(19) United States
(12) Patent Application Publication
(10) Pub. No.: US 2025/0223140 A1
(43) Pub. Date: Jul. 10, 2025

(54) Centrifugal Electromechanical Actuator

(71) Applicant: Stromag France SAS, La Guerche sur l'Aubois (FR)

(72) Inventor: Hugo Ducasse, Orange (FR)

(21) Appl. No.: 19/014,500

(22) Filed: Jan. 9, 2025

(30) Foreign Application Priority Data
Jan. 9, 2024 (FR) 2400191

(51) Int. Cl. B66D 5/30; F16D 65/14

(52) U.S. Cl. CPC B66D 5/30; F16D 65/14

(57) ABSTRACT

An electromechanical actuator (1) includes a motor (3) driving a shaft (4), a piston (5) movable in an axial direction between a low and high positions and an upper sleeve (8) slidably mounted on the shaft (4) below the piston (5). A lower sleeve (7) is attached to the shaft (4) and radially extending arms (9) are attached to the shaft (4) between the sleeves (7, 8). Flyweights (10), elongated in the axial direction, are slidably mounted on the arms (9). Lower and upper ramps (11, 12) contact the axial ends of the flyweights (10) and start from one of the sleeves (7, 8) and extend away from the shaft (4) towards the other sleeve (7, 8) such that the flyweights (10) are interposed between the ramps (11, 12) to maintain the spacing of the sleeves (7, 8). An electromagnet (14) holds the piston (5) in the high position.

### TECHNICAL FIELD

The present application relates to a centrifugal electromechanical actuator, in particular a safety brake actuator for lifting equipment.

### PRIOR ART

Lifting equipment such as cranes, overhead traveling cranes, etc. usually comprises a line provided with a drum around which suspension cables are wound, to which the load to be lifted is attached. Such lifting equipment can be used to lift extremely heavy loads, for example weighing from 50 to 500 tons.

Lifting equipment requires brakes for a number of functions, including: slowing and stopping the load as it approaches a stop position (service brake); locking the lifting equipment in its stop position, that is, when the load is at the desired height (parking brake); stopping and locking the lifting equipment in the event of a power failure or, more generally, in the event of an emergency of any kind (safety brake, also called failsafe brake).

In particular, a failsafe brake is configured to activate when it is no longer supplied with electricity (in the event of a power failure): this is known as a power failure brake or negative brake. Since the 1960s, disc brakes have become the preferred choice for this application, particularly as their heating properties pose little or no problem.

A failsafe brake generally comprises:
a disc secured to the line to be braked,
a clamp, comprising two shoes or plates capable of clamping the disc, which shoes are generally fitted with friction pads,
for each shoe or for one of the two shoe only, an energy store in the form of a spring, e.g. a washer spring or coil spring, configured to impose a compression force on said shoe in the closing direction of the brake, that is, so as to push and hold the shoes under pressure against the disc and thus close and tighten the clamp,
an electrically-operated actuator comprising a piston which, when extended, pushes a plate on which the end of the spring rests, the extended piston thus compressing the spring in the direction in which the brake opens; thus when the actuator is powered on, it can be activated to move the plate to a high position in which the spring is compressed, thereby opening the clamp and freeing the disc (and hence the line) to rotate. Alternatively, the piston is configured to act, not on the spring, but on the shoes (directly or via a mechanism) in the direction in which the brake opens.

Some older installations still have safety drum brakes. These installations comprise a pulley integral with the line to be braked, a clamp comprising two curved blocks lined with friction material, suitable for clamping and gripping the pulley, as well as an energy store and an actuator as previously described for disc brakes.

Whatever the type of safety brake considered (disc or drum), in the event of an electrical failure, the actuator suddenly becomes inoperative, releasing the spring or shoes (or curved blocks), which causes the brake to close and the load to stop.

The constraints that determine the technical specifications of safety brake actuators for lifting equipment include: the brake's working environment in terms of temperature, humidity, access, available space, etc.; the brake's stroke; the braking force imposed by the spring, which the actuator must counteract to open the brake, the spring itself being sized according to the loads to be lifted; the time taken to open; the brake response time (in the closing direction) in the event of the actuator's power supply being cut off; the possibility of closing the brake gradually to slow the descent of a load.

The actuator used to open a brake can be electrohydraulic, electromagnetic or electromechanical.

Electrohydraulic actuators present a risk of fluid leakage. In the event of a leak, the actuator may become inoperative, resulting in a production stoppage so that the actuator can be repaired and/or replaced. To keep the oil circuit closed and the oil (fluid) contained, electro-hydraulic actuators are fitted with a number of hermetic seals, all of which are wear parts requiring regular replacement, resulting in undesirable production stoppages and significant maintenance costs.

In addition, when the brake is to be used in a very hot environment, for example in a steelworks, the electrohydraulic actuator fluid must be a high-temperature-stable oil. Above a certain temperature, all known actuator oils are flammable, and the consequences of an oil leak can be dramatic. Conversely, in very cold environments, it may be necessary to fit the actuator with a fluid heating system, which adds to the weight and cost of the actuator, and increases the risk of failure. Furthermore, oils are generally environmental contaminants. Low-flammability and/or biodegradable oils do exist, but they are generally more expensive and less effective.

Without an oil circuit, electromagnetic or electromechanical actuators (e.g. ball or screw) do not have the above-mentioned disadvantages. But they generally suffer from response times that are longer (when closing, in the event of power failure), or even too long.

Also known is the electromechanical centrifugal actuator disclosed by GB687222. This actuator comprises:
an actuating rod mounted so as to slide in an axial direction, the sliding of the actuating rod towards the outside of the actuator causing the brake to close, while the sliding of the actuating rod towards the inside causes the brake to open,
a coil spring which, when compressed, tends to move the actuating rod towards the inside of the actuator (closing the brake),
an electric motor,
a square shaft rotated by the electric motor,
two lower arms whose proximal ends are rigidly attached to the shaft at a low attachment point,
a sleeve slidably mounted on the shaft between a low resting position above the attachment point of the lower arms and a high position which depends on the speed of rotation of the shaft, which sleeve tends to compress the spring and move the actuating rod outwards when it moves away from its low position under the effect of the rotation of the shaft,
two upper radial connecting rods hinged to the sleeve at their proximal ends,
two mass-linkage elements connecting, on either side of the shaft, the distal ends of one of the lower arms and one of the upper connecting rods.

When the motor is stopped, the sleeve is in the down position and the upper connecting rods are folded against the shaft. Rotation of the shaft causes the upper connecting rods to extend, driven by the mass-linkage elements which are propelled radially outwards by centrifugal force, causing the sleeve to move upwards, compressing the spring and subsequently opening the brake. The final compression of the spring depends on the stroke of the sleeve and therefore, among other things, on the motor speed.

The advantage of this brake is that it has no oil circuit, but due to its architecture, it has a short stroke which limits its possible applications.

### DISCLOSURE OF THE INVENTION

The invention aims to overcome at least one of the aforementioned disadvantages by providing a centrifugal electromechanical actuator with a longer stroke than known electromechanical actuators for use in a safety brake on lifting equipment capable of lifting very heavy loads, for example from 50 to 500 tons. The invention also aims to provide an actuator with a considerably reduced response time.

In particular, one aim of the invention is to provide an electromechanical actuator with a stroke of up to 60 mm and a response time of less than 300 ms in the event of a power failure.

For this purpose the invention proposes an electromechanical actuator comprising:
a motor,
a shaft rotated by the motor,
a piston, which can be moved in an axial direction between a low position and a high position,
an upper sleeve, which is slidably mounted on the shaft and rests on the piston when the shaft is rotated.

The electromechanical actuator according to the invention is characterized in that it comprises:
a lower sleeve attached to the shaft,
one or more (preferably at least two) radially extending arms, attached to the shaft between the lower and upper sleeves,
for each of said arms, a flyweight having an elongated shape in the axial direction, said flyweight being slidably mounted on said arm,
for each of said flyweights, a lower ramp and an upper ramp in contact with the axial ends of the flyweight, which lower and upper ramps follow curves starting respectively from the lower and upper sleeves and moving away from the shaft towards the other sleeve, each of the flyweights thus being interposed between two ramps in order to keep the sleeves spaced apart,
an electromagnet to hold the piston in the high position.

According to particular embodiments of the invention, the electromechanical actuator further complies with the following features, implemented individually or in any technically possible and operative combination.

In some embodiments, the electromagnet comprises a frame containing a coil, incorporated into the actuator housing, for example on a top wall of said housing, and the piston comprises an armature configured to be attracted by said coil.

In some embodiments, each flyweight has a roller at each of its axial ends, configured to mate with a rail formed in the corresponding ramp.

In some embodiments, each of the upper and lower ramps has a stop at its free end, preventing the axial end of the associated flyweight from disengaging from said ramp.

In some embodiments, there are three arms arranged at 120° angles to each other around the shaft, as well as flyweights, lower ramps (extending from the lower sleeve) and upper ramps (extending from the upper sleeve). The forces exerted on the shaft via the ramps and sleeves by the radial displacement of the flyweights are thus perfectly balanced, enabling the upper sleeves to slide along the shaft with limited friction and without risk of jamming, and ultimately preventing the shaft from bending.

The invention extends to a negative brake equipped with an actuator according to the invention. More particularly, the invention extends to a negative brake, comprising:
a disc,
a clamp with two shoes framing the disc,
a spring configured to impose a pressure force on at least one of said shoes in the direction in which the clamp closes,
an actuator configured to counteract the action of the spring and allow the clamp to open, characterized in that the actuator is an actuator according to the invention, i.e. as described above.

In some embodiments, the spring and actuator are dissociated and arranged in parallel with each other, with the actuator piston not acting directly on the spring.

In some embodiments:
the axial direction of the actuator and the spring axis are vertical, while the direction of movement of the brake shoes is horizontal,
the brake comprises an upper rocker arm mounted to pivot about a horizontal axis, and connected to the shoes by a mechanism configured to transform a pivoting movement of the rocker arm upwards, respectively downwards, into a horizontal force on the shoes in the direction of opening, respectively closing, of said shoes,
the spring has an upper end connected to the rocker arm so as to pull it downwards (i.e. in the direction of brake closure),
the actuator piston comprises an actuating rod extending from an actuator housing, which actuating rod is connected to the rocker arm (104) so as to push the latter upwards (in the brake opening direction) when the piston—and hence the actuating rod—is moved upwards

### BRIEF DESCRIPTION OF THE DRAWINGS

The invention, according to an embodiment, will be well understood and its advantages will become clearer on reading the following detailed description, given by way of indication and in no way limitingly, with reference to the appended drawings.

FIG. 1 shows an example of an actuator according to the invention, seen in perspective with part of its housing removed, the piston and upper sleeve of the actuator being in the low position.

FIG. 2 shows the actuator of FIG. 1, still in perspective but with the piston and upper sleeve in an intermediate position.

FIG. 3 shows the actuator of FIGS. 1 and 2, still in perspective but with the piston and upper sleeve in the high position.

FIG. 4 shows the actuator of FIGS. 1 to 3 in perspective, with the piston held in the high position and the upper sleeve lowered to the low position.

FIG. 5 is a perspective view of a disc brake incorporating an actuator according to the invention, which may be that of FIGS. 1 to 4.

FIG. 6 shows the disc brake of FIG. 5, seen in perspective from a different viewpoint.

FIG. 7 is a perspective view of a drum brake incorporating an actuator according to the invention, which may be that of FIGS. 1 to 4.

### DETAILED DESCRIPTION

Identical elements shown in the above figures are identified by identical numerical references.

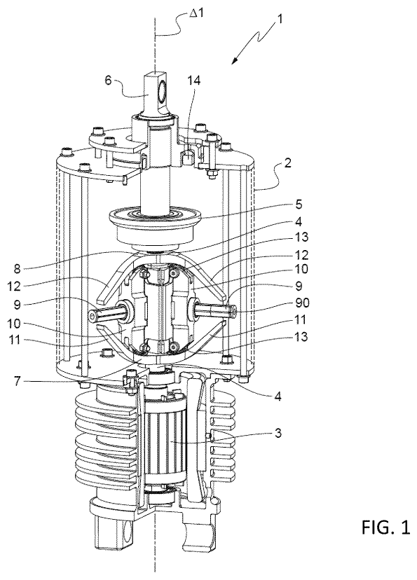

FIGS. 1 to 4 show an actuator 1 according to the invention. It comprises:
a housing 2, partly transparent, from which a portion has been cut out in the figures to show the various parts making up the actuator;
an electric motor 3 arranged at the bottom of the actuator; by way of example, the motor 3 can be a standard three-phase asynchronous motor, supplied at 400V,
a shaft 4, which extends in an axial direction Δ₁ of the actuator and is driven in rotation by the motor 3; in use, in particular when associated with a safety brake of a hoist, the actuator 1 is arranged so that its axial direction Δ₁ is vertical,
a piston 5 slidably mounted on the shaft 4, provided with an armature configured to be attracted by the electromagnet 14 described below, and provided with an actuating rod 6 projecting from an upper wall 20 of the housing 2;
a lower sleeve 7, attached to the shaft 5 at a low point, i.e. close to the motor 3;
an upper sleeve 8 slidably mounted on the shaft 5 above the lower sleeve 7;
three radially extending arms 9, arranged at 120° angles to each other and attached to the shaft 4 between the lower and upper sleeve;
three inertia weights 10, each inertia weight being slidably mounted on one of the arms 9; to this end, each inertia weight has a central hole through which it is threaded onto the arm 9;
an electromagnet 14, shown here very schematically, with reference 14 pointing to a frame incorporating a coil (not shown).

The flyweights have a dimension in the axial direction which corresponds substantially to the desired stroke of the actuator. This dimension is advantageously of the order of 60 mm.

For each arm 9, the actuator 1 comprises a lower ramp 11 formed as an extension of the lower sleeve 7. When the motor is at a standstill (FIG. 1), the lower ramp 11 extends from the lower sleeve 7 to the distal end 90 of the arm. The lower ramp 11 follows a curve inscribed in a longitudinal (vertical) plane comprising the axis of the shaft 4 and the axis of said arm 9; this curve starts from the lower sleeve 7 and moves radially away from the shaft 4 towards the upper sleeve 8 (i.e. upwards on the appended figures).

Likewise, for each arm 9, the actuator 1 comprises an upper ramp 12 formed as an extension of the upper sleeve 8. When the motor is at a standstill (FIG. 1), the upper ramp 12 extends from the upper sleeve 8 to the distal end 90 of the arm. The upper ramp 12 thus follows a curve inscribed in the longitudinal plane that includes the axis of the shaft 4 and the axis of said arm 9; this curve starts from the upper sleeve 8 and moves radially away from the shaft 4 towards the lower sleeve 7 (downwards in the figures).

Each flyweight 10 also lies essentially in the longitudinal plane that includes the axis of the shaft 4 and the axis of the arm 9 on which the flyweight is slidingly mounted. The flyweight 10 is set between the lower 11 and upper 12 ramps associated with said arm. It has an elongated shape in the axial direction. The length (dimension in axial direction) of the flyweight 10 defines the distance between the upper and lower sleeves when the actuator is at rest (motor at standstill, FIG. 1). As will become clear later on, the flyweight length also defines the maximum possible actuator stroke. The longer the flyweight, the greater the mass of the flyweight can be, and thus the greater the actuator force. In operation, the real stroke of the actuating rod 6 depends on the radial distance covered by the flyweights 10 on the arms 9.

At each of its axial ends, the flyweight 10 comprises a bearing 13 engaged in a rail (not shown) formed in the ramp 11 or 12 against which said axial end of the flyweight rests.

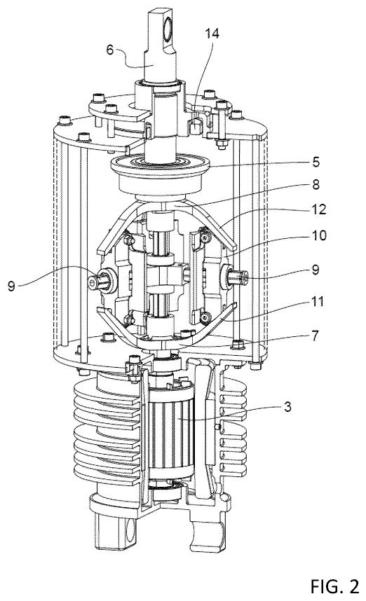

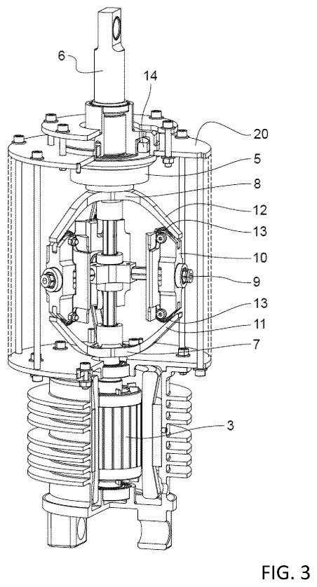

When the motor is at rest, the flyweights 10 are pressed against the shaft 4. When the motor is running and the shaft 4 is rotating, the centrifugal force propels the flyweights 10 radially outwards. They then push on the upper 12 and lower 11 ramps with which they are respectively associated, moving the upper 8 (sliding) sleeve away from the lower 7 (fixed) sleeve, causing the piston 5 to move upwards, as can be seen in FIGS. 2 and 3.

FIG. 3 shows the extreme positions of the flyweights 10, when the radial ends of the weights reach the ends of the ramps 11 and 12. The piston 5 here is in a high position, in which its armature is pressed against the top wall 20 of housing 2, or rather against the electromagnet frame 14, and actuating rod 6 is in the fully extended position. Opening the brake, i.e. moving the piston from its low position (FIG. 1) to its high position (FIG. 3), takes around 200 ms.

In the event of a power failure while the actuator is in the configuration shown in FIG. 3, the motor 3 and shaft 4 stop, and the electromagnet 14 is deactivated. No longer subject to centrifugal force, the flyweights 10 return to their initial position against the shaft 4 under their own weight and that of the upper sleeve 8. The upper sleeve 8 and piston 5 are in the low position, with the actuating rod in its retracted position, as shown in FIG. 1. The descent of the piston and upper sleeve 8, slightly slowed by the flyweights 10, can take up to 300 ms.

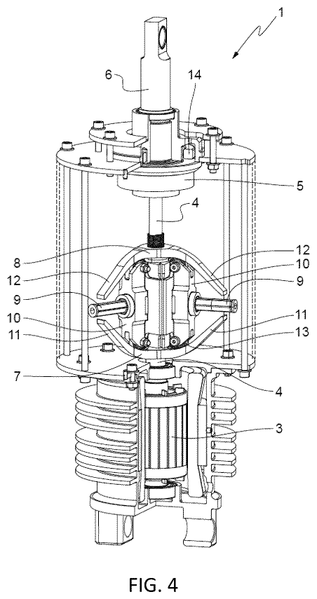

If the motor 3 is stopped while the piston 5 is in the high position and the electromagnet 14 is active, the centrifugal force is removed and the flyweights 10 return to their initial position against the shaft 4, under their own weight and that of the upper sleeve 8. The actuator may further comprise a small spring above the upper sleeve 8 (this spring can be seen in FIG. 4), allowing the upper sleeve 8 and the weights 10 to be lowered slightly faster. This spring overcomes the inertia of the mechanism at the start of the downward movement of the sleeve and weights.

Thus, if the motor is switched off and the electromagnet 14 is activated, the upper sleeve 8 is in the low position, while the piston 5, held by the electromagnet 14, remains in the high position, as shown in FIG. 4. The electromagnet thus enables the motor to be switched off while maintaining the actuator force, thus preventing the motor from overheating and failing. The electromagnet improves the actuator's reliability and robustness, and extends its service life.

In the event of a power failure while the actuator is in the configuration shown in FIG. 4, the electromagnet 14 is instantly deactivated and the piston 5 falls under its own weight. Since it is not being braked by the upper sleeve 8 and the flyweights 10, the piston 5 returns to its low position within a time (known as response time) of around 100 ms. If the actuator is combined with a lifting equipment safety brake, the fall of the load carried by the lifting equipment is instantly stopped. The electromagnet 14 also considerably reduces the response time of the actuator and associated brake.

If brake closure is desired during normal operation, i.e. in the absence of a power failure, it is possible to achieve less abrupt (or even gradual) brake closure by deactivating electromagnet 14 while initially holding the piston 5 in the high position owing to the motor 3 and then stopping the motor. Decelerating the motor (before it comes to a complete stop) can even be used to manage the lowering of the load.

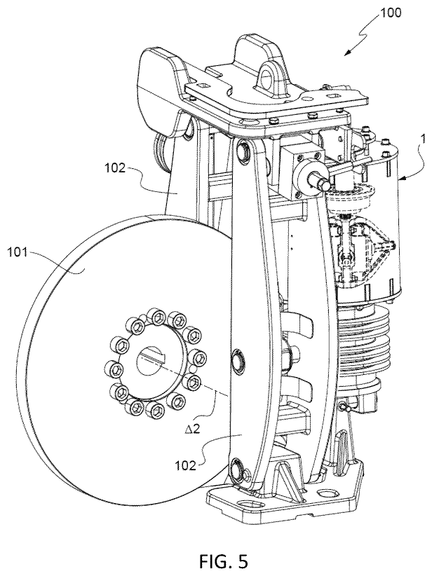

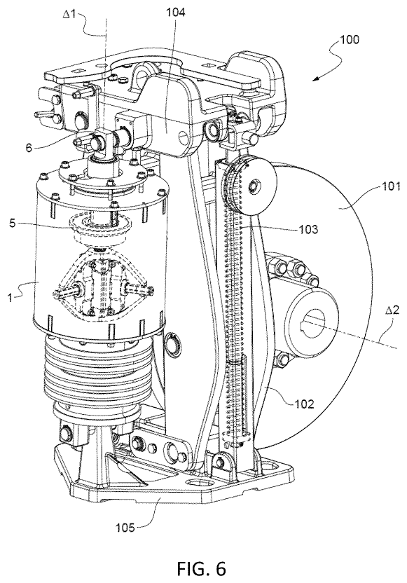

FIGS. 5 and 6 show the actuator shown in FIGS. 1 to 4 integrated in a disc brake 100. This brake comprises:
a disc 101, designed to be mounted on a line to be braked (not shown),
on either side of the disc 101, shoes 102 parallel to the front faces of the disc 101 and forming a clamp that grips the disc 101,
a spring 103, for example a coil spring as shown in FIG. 6, configured to push one or both shoes in the brake closing direction (i.e. towards each other),
the actuator 1.

In the illustrated example, spring 103 is substantially parallel to the axial direction Δ₁ of the actuator, this being orthogonal to the working direction Δ₂ of the shoes (i.e. the axis of disc 101). It is easy to see that this architecture results in a particularly compact brake, with limited dimensions in the vertical direction.

The brake therefore further comprises a rocker arm 104 and a mechanism capable of transforming an upward and downward pivoting movement of this rocker arm into a movement of the brake shoes 102 in the directions in which the brake opens and closes, respectively. This mechanism is not shown in detail, as the person skilled in the art will be able to design it using their general knowledge.

The lower end of the actuator housing 2 is attached to a brake base 105. Similarly, the lower end of the spring 103 is attached to the base 105.

The actuating rod 6 of the actuator is connected to the rocker arm 104 so that the extension of this rod causes the rocker arm to pivot upwards, i.e. imposes a force on the shoes 102 urging the brake to open. Conversely, the upper end of the spring is connected to the rocker arm 104 so that the spring (which, in the example shown, works in tension) causes the rocker arm to pivot downwards, i.e. imposes a force on the shoes 102 urging the brake to close.

The stroke of the actuator 1 counteracts the action of the spring 103 and lifts the shoes 102 off disc 101 to open the brake.

It should be noted that spring compression depends on the displacement of the actuating rod 6, and therefore on the actuator force, which depends not only on the speed of rotation of the motor 3, but also on the stroke of the sleeve itself (the closer the sleeve approaches the high position, the greater the centrifugal force, and therefore the greater the actuator force). Thus, even if the motor is at a stabilized speed, the effort continues to increase with the stroke of the sleeve. However, in an actuator according to the invention, the sleeve can have a longer stroke than in a prior art actuator such as GB687222. For the same motor, the invention's actuator can therefore develop a higher force than previous actuators.

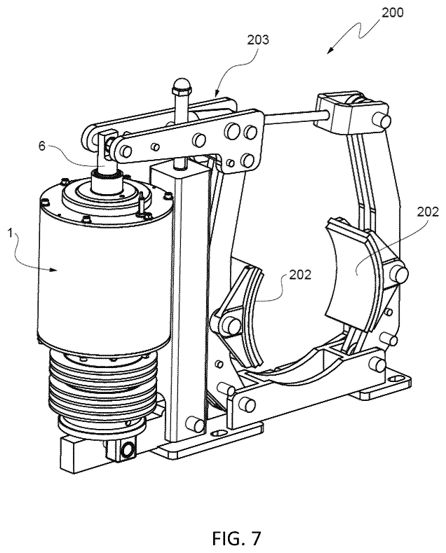

FIG. 7 shows a drum brake 200. This brake usually comprises two blocks 202 (similar to the claimed shoes) forming a clamp that grips a drum (not shown), and is remarkable in that it comprises an actuator 1 according to the invention. It will not be described in greater detail here, as the person skilled in the art will be able to design the mechanism 203 that transforms the vertical displacements of the actuating rod 6 into the forces of the blocks 202 against the drum.

As the actuator 1 has no oil circuit, it can be used in very hot environments without risk of fire, and in very cold environments without risk of oil solidification.

In addition, its relatively long stroke enables it to develop a high force, making it ideal for use as a safety brake on lifting equipment designed to lift loads of up to 500 tons or more. The use of the actuator's electromagnet 14 keeps the brake open without using the motor 3, and ensures instant brake closure (in less than 100 ms) in the event of a power failure.

1. An electromechanical actuator (1) comprising:
a motor (3);
a shaft (4) rotated by the motor (3);
a piston (5), which can be moved in an axial direction (Δ₁) between a low position and a high position;
an upper sleeve (8), which is slidably mounted on the shaft (4) and rests on the piston (5) when the shaft (4) is rotated;
characterized by
a lower sleeve (7) attached to the shaft (4);
one or more radially extending arms (9) attached to the shaft (4) between the lower sleeve (7) and the upper sleeve (8), each of the arms (9) having a flyweight (10) slidably mounted on the arm (9), the flyweight (10) having an elongated shape in the axial direction;
for each of the flyweights (10), a lower ramp (11) in contact with one axial end of the flyweight (10) and following a curve starting from the lower sleeve (7) and moving away from the shaft (4) towards the upper sleeve (8) and an upper ramp (12) in contact with the other axial end of the flyweight (10) and following a curve starting from the upper sleeve (8) and moving away from the shaft (4) towards the lower sleeve (7), each of the flyweights (10) thus being interposed between lower and upper ramps (11, 12) in order to keep the lower and upper sleeves (7, 8) spaced apart; and,
an electromagnet (14) to hold the piston (5) in the high position.

2. The electromechanical actuator (1) according to claim 1, wherein the electromagnet (14) comprises a frame containing a coil, incorporated in a housing (2) of the electromechanical actuator (1), and the piston (5) comprises an armature configured to be attracted by the coil.

3. The electromechanical actuator (1) according to claim 1, wherein each flyweight (10) has a bearing (13) at each of its axial ends, configured to cooperate with a rail provided in the corresponding lower or upper ramp (11, 12).

4. The electromechanical actuator (1) according to claim 1, wherein each of the lower and upper ramps (11, 12) has a stop at its free end, preventing the axial end of the associated flyweight (10) from disengaging from the lower and upper ramps (11, 12).

5. The electromechanical actuator (1) according to claim 1, wherein the arms (9) are three in number, arranged at 120° to one another around the shaft (4), as are the flyweights (10), the lower ramps (11) and the upper ramps (12).

6. A negative brake (100 or 200), comprising:
a disc (101) or drum;
a clamp with two shoes (102; 202) framing the disc (101) or drum;
a spring (103) configured to impose a pressure force on at least one of the shoes (102; 202) in the direction in which the clamp closes; and,
the electromechanical actuator (1) of claim 1, the electromechanical actuator configured to counteract the action of the spring (103) and allow the clamp to open.

7. The negative brake according to claim 6, wherein the spring (103) and the electromechanical actuator (1) are dissociated and arranged in parallel with each other, the piston (5) of the electromechanical actuator (1) not acting directly on the spring (103).

8. The negative brake according to claim 6, wherein:
the axial direction (Δ₁) of the electromechanical actuator (1) and the axis of the spring (103) are vertical, while the direction (Δ₂) of movement of the shoes (102) is horizontal;
the brake comprises an upper rocker arm (104) mounted to pivot about a horizontal axis and connected to the shoes (102) by a mechanism configured to transform a pivoting movement of the rocker arm (104) upwards into a horizontal force on the shoes (102) in the direction of opening the shoes (102) and downwards into a horizontal force on the shoes (102) in the direction of closing the shoes (102);
the spring (103) has an upper end connected to the rocker arm (104) to pull it downwards; and,
the piston (5) of the electromechanical actuator (1) comprises an actuating rod (6) extending from a housing (2) of the electromechanical actuator (1), which actuating rod (6) is connected to the rocker arm (104) so as to push the rocker arm (104) upwards when the piston (5) is moved upwards.
